(19) United States
(12) Patent Application Publication
(10) Pub. No.: US 2010/0200562 A1
(43) Pub. Date: Aug. 12, 2010

(54) System for Keeping a Hose Ice Free

(75) Inventor: James Donald Koskey, JR., Manitou Springs, CO (US)

Correspondence Address: LAW OFFICE OF DALE B. HALLING, 3595 FOUNTAIN BOULEVARD SUITE A2, COLORADO SPRINGS, CO, 80910, US

(73) Assignee: K & H Manufacturing

(21) Appl. No.: 12/366,868

(22) Filed: Feb. 6, 2009

(51) Int. Cl. H05B 3/02; H05B 3/54; H05B 1/02

(52) U.S. Cl. 219/386; 219/385; 219/494

(57) ABSTRACT

A system for keeping a hose ice free has a flexible housing for holding a garden hose. The housing has an interior space that holds a heater. A thermostat controls the heater. The heater may be a foil heater. An insulating layer is placed between heater and the housing. The system may have two thermostats that control the heater. One thermostat measures an exterior temperature and when the temperature is just above the freezing point of water the thermostat turns off the power to the heater. A second thermostat is in series with the first thermostat. The second thermostat measures a temperature of the interior space. The second thermostat is set to turn off the power to the heater when the interior temperature reaches around room temperature, approximately eighty degrees Fahrenheit. The housing may have a drawstring or zipper to allow access to the interior space.

### BACKGROUND OF THE INVENTION

In the winter garden hoses become clogged with ice and may break or break the faucet if left connected to a faucet. However, many people need to use a garden hose during the winter to fill up hot tubs, ornamental ponds, stock tanks and a variety of other uses. There have been attempts to provide a heated garden hose. For instance, there have been garden hoses with heating wires running inside the housing of the hose. This requires setting up a different production system and specialized machinery for garden hoses. Alternatively, there have been heated hoses with the heating element running on the outside of the rubberized hose with an insulating sleeve covering the hose and heating element the entire length of the hose. This also requires specialized machinery to produce. Because the prior designs require specialized machinery to produce they are difficult to manufacture and this causes the price of these heated hose to be well over one hundred dollars and therefore out of the reach of the average consumer.

Thus, there exists a need for a system that allows a garden hose to be used in the winter without clogging up with ice or breaking and is inexpensive and relatively simple to manufacture.

### BRIEF SUMMARY OF INVENTION

A system for keeping a hose ice free that overcomes these and other problems has a flexible housing for holding a garden hose. The housing has an interior space that holds a heater. A thermostat controls the heater. The heater may be a foil heater. An insulating layer is placed between heater and the housing. The system may have two thermostats that control the heater. One thermostat measures an exterior temperature and when the temperature is just above the freezing point of water the thermostat turns off the power to the heater. A second thermostat is in series with the first thermostat. The second thermostat measures a temperature of the interior space. The second thermostat is set to turn off the power to the heater when the interior temperature reaches around room temperature, approximately eighty degrees Fahrenheit. The housing may have a drawstring or zipper to allow access to the interior space.

The system allows the user to place their garden hose inside the housing and have the system keep the hose warm enough so that water does not freeze. This keeps the hose free from ice and flexible for ease of use.

### BRIEF DESCRIPTION OF THE SEVERAL VIEWS OF THE DRAWINGS

FIG. 1 is a side view of a system for keeping a hose ice free in accordance with one embodiment of the invention;

FIG. 2 is a side view of a system for keeping a hose ice free in accordance with one embodiment of the invention;

FIG. 3 is an exploded view of a portion of the system for keeping a hose ice free in accordance with one embodiment of the invention;

FIG. 4 is a side view of a system for keeping a hose ice free in accordance with one embodiment of the invention; and

FIG. 5 is a circuit diagram of the system for keeping a hose ice free in accordance with one embodiment of the invention.

### DETAILED DESCRIPTION OF THE INVENTION

The invention relates to a system for keeping a hose ice free that has a flexible housing for holding a garden hose. The housing has an interior space that holds a heater. A thermostat controls the heater. The heater may be a foil heater. An insulating layer is placed between heater and the housing. The system may have two thermostats that control the heater. One thermostat measures an exterior temperature and when the temperature is just above the freezing point of water the thermostat turns off the power to the heater. A second thermostat is in series with the first thermostat. The second thermostat measures a temperature of the interior space. The second thermostat is set to turn off the power to the heater when the interior temperature reaches around room temperature, approximately eighty degrees Fahrenheit. The housing may have a drawstring or zipper to allow access to the interior space.

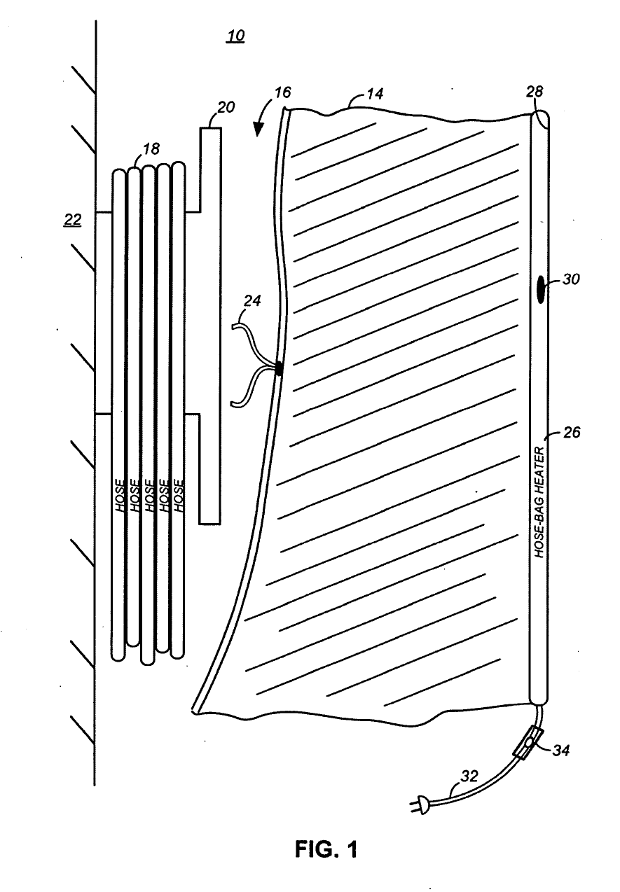

FIG. 1 is a side view of a system 10 for keeping a hose ice free in accordance with one embodiment of the invention. The system 10 has a housing 14 that defines an interior space 16. The interior space 16 encapsulates the hose 18. The hose 18 is shown on a hose hanger 20 mounted to a house 22 or other structure. The housing 14 is shown with a drawstring 24 to provide access to the interior space 16. A heater 26 is inside the housing 14 and attached to an interior wall 28 of the housing 14. The heater 26 has an interior thermostat 30 and an electrical cord 32 to provide power. An exterior thermostat 34 is mounted to the electrical cord 32. Note the housing 14 may be made of cloth or a flexible plastic.

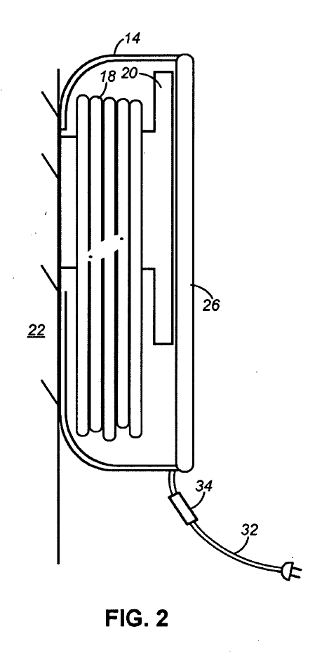

In operation, the user loosens the drawstring 24 and places the housing 14 over the hose 18. Once the housing 14 is in place the drawstring 24 is pulled tight to wrap around the housing 14 and hold heat inside the housing 14. This is shown in FIG. 2. The heater 26 will turn on and heat up the hose 18 if the exterior temperature measured by the exterior thermostat 34 is less than a temperature just above freezing or around thirty five degree Fahrenheit. In addition, the interior thermostat has to measure a temperature below room temperature or about eighty degrees Fahrenheit. Both thermostats' conditions must be met in order for the heater 26 to turn on. In one embodiment there may be two interior thermostats that both must measure a temperature below room temperature to turn on the heater 26.

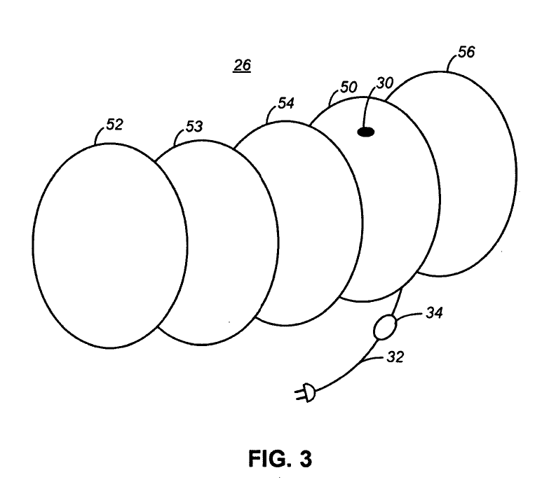

FIG. 3 is an exploded view of a portion of the system for keeping a hose ice free in accordance with one embodiment of the invention. This view shows the construction of the heater 26, which has foil heater 50 with a thermostat 30. A V-O PVC (What does V-O stand for PolyVinyl Chloride) sheet 52 is used for water proofing and fits against the interior wall of the housing. An insulating layer 53 is next to the first layer 52 and may be a thin foam. A second plastic layer 54 is inserted to add rigidity. Next is the foil heater layer 50. Last is a second layer of V-O PVC 56. The layers 50, 52, 53, 54, 56 are adhered together. In one embodiment, the layers are welded together along the perimeter.

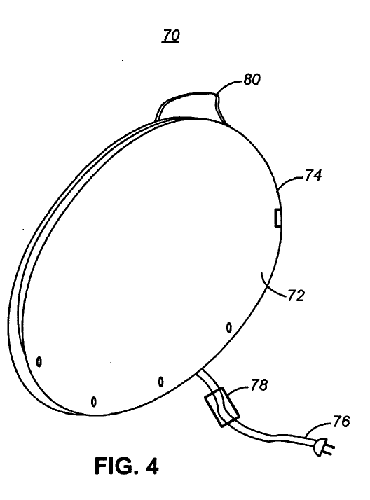

FIG. 4 is a side view of a system 70 for keeping a hose ice free in accordance with one embodiment of the invention. In this embodiment of the system 70 there is a housing 72 that is disk shaped. The housing 72 has a reclosable opening formed by a zipper 74. The zipper 74 provides access to the interior of the housing 72 which holds the hose. A heater, such as that show in FIG. 3, is enclosed in the housing 72 and generally attached to an interior wall. An electrical cord 76 extends outside the housing 74. A thermostat 78 is attached to the electrical cord 78. The housing is provided with a handle 80. This embodiment of the system for keep a hose ice free works similarly to the embodiment shown in FIGS. 1 & 2, except that it works with a hose that is not mounted to a hose hanger.

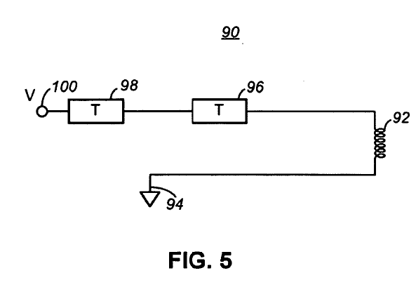

FIG. 5 is a circuit diagram 90 of the system for keeping a hose ice free in accordance with one embodiment of the invention. A heater 92 has a first end connected to ground 94 and a second end connected to a first thermostat (T) 96. The first thermostat 96 is in series with a second thermostat 98. The second thermostat 98 is connected to a power source 100. There may be more than two thermostats in series. The thermostats 98, 96 are designed to open the circuit when they are above a threshold temperature. Thus, both thermostats 96, 98 have to be below their threshold temperatures in order for the heater 92 to receive power.

Thus there has been described a system that allows a garden hose to be used in the winter without clogging up with ice or breaking and is inexpensive and relatively simple to manufacture.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A system for keeping a hose ice free, comprising:
a flexible disk shaped housing forming a interior pocket and having a reclosable opening;
a heater enclosed in the interior pocket; and
a thermostat controlling the heater.

2. The system of claim 1, further including an electrical cord connected to the heater and extending outside the flexible disk shaped housing.

3. The system of claim 2, wherein the thermostat is connected to the electrical cord on the portion of the electrical cord outside the flexible disk shaped housing.

4. The system of claim 1, wherein the heater is attached to an interior surface of the flexible disk shaped housing.

5. The system of claim 4, further including an insulating layer between the heater and the flexible disk shaped housing.

6. The system of claim 1, wherein the reclosable opening is a drawstring.

7. A system for keeping a hose ice free, comprising:
a housing for holding a hose, the housing having an interior space;
a foil heater enclosed in the interior space; and
a thermostat controlling the foil heater.

8. The system of claim 7, further including an insulating layer between the foil heater and the housing.

9. The system of claim 8, wherein the thermostat is attached to an electrical cord.

10. The system of claim 9, wherein the thermostat is set to turn off power to the foil heater when the temperature is slightly above the freezing point of water.

11. The system of claim 7, further including a handle attached to the housing.

12. The system of claim 7, wherein the housing has a plurality of drain holes.

13. A system for keeping a hose ice free, comprising:
a first thermostat measuring an exterior temperature;
a housing for holding a hose and defining an interior space;
a foil heater enclosed in the interior space of the housing and controlled by a first thermostat; and
a second thermostat measuring an interior temperature and controlling the foil heater.

14. The system of claim 13, wherein the first thermostat and the second thermostat are electrically serially connected to a power source.

15. The system of claim 13, further including an insulating layer between the foil heater and the housing.

16. The system of claim 13, wherein the first thermostat is set to turn off power to the foil heater when the exterior temperature is just above freezing.

17. The system of claim 13, wherein the second thermostat is set to turn off power to the foil heater when the interior temperature is at or above room temperature.
